(19) United States
(12) Patent Application Publication
(10) Pub. No.: US 2013/0238510 A1
(43) Pub. Date: Sep. 12, 2013

(54) Project and Document Management System with Automatic Metadata Encoding

(71) Applicant: Gunnar Wieboldt, Chapel Hill, NC (US)

(72) Inventor: Gunnar Wieboldt, Chapel Hill, NC (US)

(21) Appl. No.: 13/779,462

(22) Filed: Feb. 27, 2013

Related U.S. Application Data
(60) Provisional application No. 61/604,327, filed on Feb. 28, 2012.

(51) Int. Cl. G06Q 10/10

(52) U.S. Cl. CPC G06Q 10/103
USPC 705/301

(57) ABSTRACT

A project and document management system with automatic metadata encoding is enclosed. In the system, a data repository is provided, and a number of computing devices are connected to the data repository through a communication network to store their data in the data repository. On each computing device, an activity frame automatically associates sets of metadata with data generated by application programs. The application frame may take the form of a virtual workspace or set of workspaces, each workspace associated with its own set of metadata, such that everything a user does, receives, or acts on while in that workspace is associated with the workspace's set of metadata. Virtual workspaces may have hierarchical or other relationships, and related workspaces may inherit or share parts of their sets of metadata. Dashboards and analytics may be used to indicate the status of single workspaces or related workspaces addressing particular tasks.

### BACKGROUND OF THE INVENTION

1. Field of the Invention

In general, the invention relates to software, and more specifically to software for project and document management with automatic metadata encoding.

2. Description of Related Art

Today's business endeavors generate massive amounts of information, any of which may need to be accessed on demand. This information takes many forms, and is generated by many different applications and processes. Some of the information relates to the business's internal affairs, strategy, personnel, legal compliance, and other such matters. Other information relates to external affairs, such as communications with clients, customers, and vendors.

One difficulty with managing all of that information is that it is generated in multiple formats by multiple, different applications. In a modern business, employees may communicate via e-mail, instant message, text message, and voice mail. Additionally, documents, photographs, and media files are often worked on collaboratively. Each form of communication and work may involve different applications and different file or information formats.

Controlling, cataloging and storing all of that information in an accessible format is a major challenge in most businesses. Document management systems do exist and are commonplace in many settings. For example, in a law firm environment, a document management system might require a user to manually input client and matter information for each document on saving that document. In order to find and access the information again, the user searches for the client and/or matter information. These systems do allow information to be retrieved, and they do allow users to collaboratively edit and revise documents. However, in order to access information, users must manually associate identifying information, often called metadata, with each document.

Document management systems do not always allow all types of documents and information to be stored. Even if a document management system theoretically allows a wide range of file formats to be stored, it often requires the user to store many types of documents in the system manually. For example, a user may need to manually enter an e-mail from his or her e-mail program into the document management system. Additionally, while a document management system may index documents in a retrievable manner, for example, by client and matter number, most document management systems give no indication as to how one matter relates to another.

Therefore, even if a traditional document or project management system does perform adequately, it may not be sufficient to allow an organization to make effective use of its information and facilitate collaboration between team members working on the same project while allowing easy access to data necessary for legal and regulatory compliance.

### SUMMARY OF THE INVENTION

One aspect of the invention relates to a system managing projects and documents that automatically encodes metadata. The system provides a central data repository or repositories which is connected to a plurality of user-level computing systems via a communication network, such as the Internet. Each computing system runs an activity frame routine that stores and indexes data generated by one or more applications running on the computing system. The activity frame automatically encodes appropriate metadata along with the data generated by the applications.

In some embodiments, the activity frame may take the form of a workspace or portal from which a user can activate and use various applications. Multiple workspaces may have hierarchical or user-defined relationships with one another that also define the type or nature of metadata that is to be encoded along with the data generated in each workspace. In some embodiments or applications, the types of metadata that are collected in different task areas are predefined or defined using templates. In other embodiments and applications, users may define their own templates or manually specify types of metadata that are to be collected.

These and other aspects, features, and advantages of the invention will be set forth in the description that follows.

### BRIEF DESCRIPTION OF THE DRAWING FIGURES

The invention will be described with respect to the following drawing figures, in which like numerals represent like features throughout the figures, and in which:

FIG. 1 is a schematic illustration of a system according to one embodiment of the invention;

FIG. 2 is an illustration of a high-level dashboard or interface for the system of FIG. 1;

FIG. 3 is an illustration of a workspace according to one embodiment of the invention;

FIG. 4 is an illustration of another example of a workspace according to an embodiment of the invention;

FIG. 5 is an illustration of a family of workspaces, illustrating both hierarchical and user-defined relationships between workspaces; and

FIG. 6 is an illustration of a business analytical dashboard.

### DETAILED DESCRIPTION

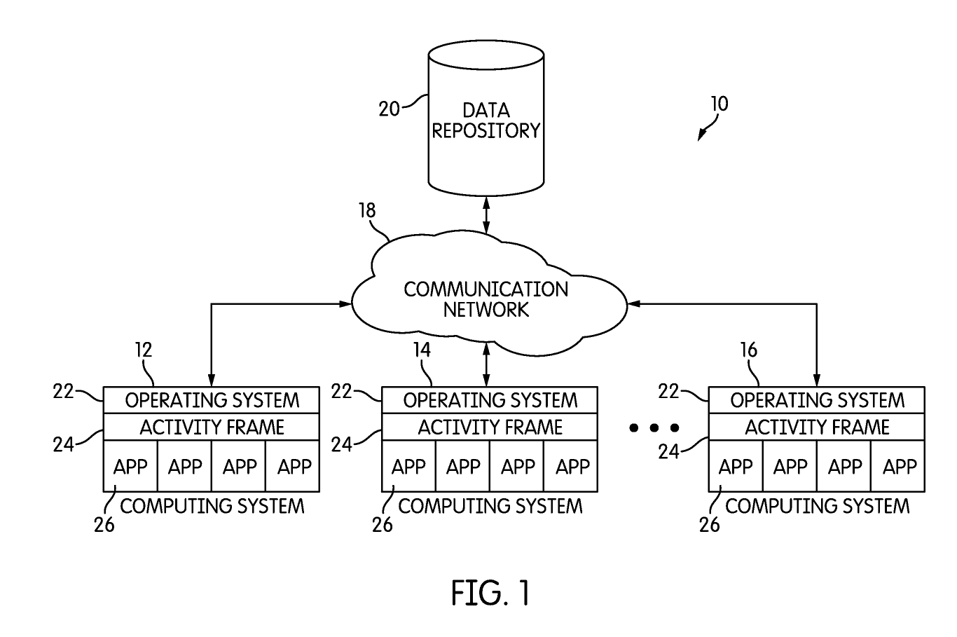

FIG. 1 is a schematic illustration of a system, generally indicated at 10, according to one embodiment of the invention. In system 10, a number of user computing systems 12, 14, 16 are connected via a communication network 18 to a data repository 20. As will be described below in more detail, in system 10, each of the computing systems 12, 14, 16 is adapted, via a software routine or routines, to store documents and information in the data repository 20 while also automatically storing metadata for the documents or information.

As used in this specification, the term “metadata” refers to contextual information that sets forth the nature of the information or how the information being stored pertains to the mission or obligations of the organization. Examples of metadata include the user who created the data, the date and time, the team members working on the project, the purpose or justification of the file or project, the type of deliverable involved (e.g., completed transaction, resolved litigation, issued patent), any deadlines or meetings associated with the data, an indication of the materiality of the data (e.g., routine, high, priority), whether or not the data is privileged or otherwise exempt from disclosure, and an indication as to the sensitivity of the data (e.g., business confidential, need to know only, public). Other specific kinds of metadata may be included for specific types of projects and data, as will be described below in more detail. Moreover, the nature and type of metadata may be tailored for each type of data and each context.

The data repository 20 may be any type of repository in which data can be stored. On the hardware level, the data repository 20 would typically be a server computer or computers connected to appropriate data storage devices, such as hard disk drives. The precise nature of the hardware will depend on the scale and capacity of the data repository, the number of users, and other conventional factors. In some cases, the data repository may be a database, such as a Structured Query Language (SQL) database. For example, the data repository 20 may be a MySQL database running on appropriate hardware.

However, if the data repository 20 is a database, it need not use SQL, or a structured language at all. Particularly for larger installations, database technologies like CouchDB and Hadoop (Apache Software Foundation, Forest Hill, Md., United States), which used so-called “unstructured” query languages and do not rely on tables to store data, may be suitable and more scalable than a SQL database.

The user computing systems 12, 14, 16 communicate with the data repository 20 via a communication network 18. The communication network 18 may be any type of network, including local area networks (LANs) and wide area networks (WANs). These include networks based on transmission control protocol/internet protocol (TCP/IP) as well as on other protocols. For example, if system 10 is installed in an office setting, the user computing systems 18 may be connected to the data repository 20 via an Ethernet network using TCP/IP. Of course, the user computing systems 12, 14, 16 may be located remotely from the data repository 20. In some cases, virtual private networks (VPNs) and other encryption systems may be used to allow user computing systems 12, 14, 16 to communicate with the data repository 20 over a public, shared network, such as the Internet. In other cases, depending on the nature of the data, encryption may not be necessary.

The data repository 20 need not be operated by the same entity that operates the user computing systems 12, 14, 16 and generates the data. In some embodiments, the data repository 20 may be operated by a different entity. For example, system 10 may make use of what is colloquially known as “cloud computing”—i.e., the data may be stored offsite by an independent entity in a shared or dedicated data repository 20.

The computing systems 12, 14, 16 may be any type of computer or device capable of performing the functions ascribed to it in this description. Exemplary computing systems include desktop and laptop computing systems as well as tablet computers and handheld devices, like smartphones. As is known in the art, each computing system 12, 14, 16 has an operating system 22, a group of routines implemented in software, hardware, or a combination of software and hardware, that controls basic machine functions and provides basic interface functions for the user. Each computing system 12, 14, 16 also runs a variety of applications 26, also known as “apps,” that provide specific functionality to perform certain tasks. Examples of applications include World Wide Web browsers, word processors, spreadsheets, presentation programs, e-mail clients, and instant message clients, to name a few.

Interposed between the operating system 22 and the applications 26 in the illustration of FIG. 1 is an activity frame 24. The activity frame 24 acts as an intermediary between the applications 26 and the operating system 22 to automatically add metadata to data generated, received, or acted upon by the applications 26. The activity frame 24 and associated workspaces and applications may also provide certain project management functions, as will be described below in more detail. In general, while the activity frame 24 is running on the computing systems 12, 14, 16, all data produced by the applications 26 is automatically tagged with metadata at the time that it is produced, at the time that it is saved, or at some other essentially concurrent time. This is done regardless of the origin of the data.

The activity frame 24 is itself an application or set of applications. Depending on the embodiment, user computing systems 12, 14, 16 may be configured to load activity frames 24 automatically upon startup, or the user may be permitted to manually load the activity frame 24. Depending on the embodiment, the activity frame 24 may be visible or invisible to the user. More particularly, while the description below focuses on certain embodiments in which the activity frame 24 provides a set of applications or functions to the user and includes a particular graphical user interface, in some embodiments, the user may simply work using conventional business applications and the activity frame may interface with those applications in the background to automatically tag data with metadata, as described above.

Most organizations have hierarchical levels of responsibility with higher-level executives responsible for organizational performance across a number of different areas, and lower-level managers responsible for the performance of a particular area, or of particular projects within that area. For that reason, activity frame 24 provides a hierarchical project management user interface. The level of the hierarchy presented to the user depends on the user's level of responsibility. For example, a higher-level executive might have a first-level interface or dashboard that shows a variety of areas of that executive's responsibility (e.g., intellectual property, general legal matters, human resources, accounting, and compliance/investigations), while lower-level managers would have dashboards that show only those areas for which they are involved, and focus on specific projects within those areas.

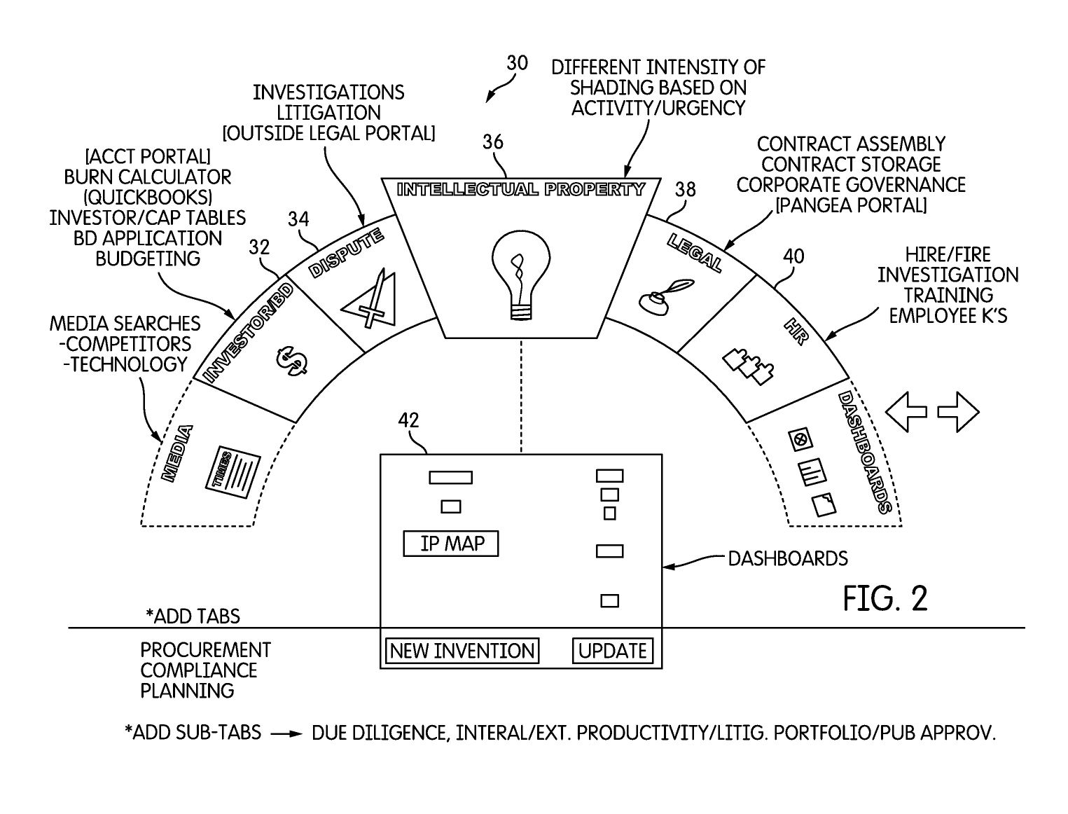

FIG. 2 is a schematic illustration of a first-level interface or dashboard 30 for the activity frame 24. The dashboard 30 shows status indicators and access points for a variety of disciplines, including investing, accounting and capitalization 32; investigations and litigation 34; intellectual property 36; legal 38; and human resources 40. Each of the status indicators 32, 34, 36, 38, 40 acts as an access point in that if a user selects the indicator 32, 34, 36, 38, 40, the activity frame 24 will load a dashboard and workspace specific for that discipline or task area. Such a dashboard 42 for the intellectual property task area 36 is shown in reduced form in FIG. 2.

One advantage of system 10 is that the dashboard 30, and in some cases, the task-specific workspaces 42, are adapted to show and alert the user to tasks and areas of responsibility that require attention. Specifically, various forms of shading and coloring can be used on the status indicators 32, 34, 36, 38, 40 for areas that require attention. For example, green shading or coloring (or the absence of shading or coloring) may indicate a task area that does not require immediate attention, while red shading may indicate a task area that requires immediate attention. Intermediate types of shading or colors, like yellow, may indicate that a task area requires some attention, but not immediate attention. System 10 may determine that a task or area of responsibility requires attention either automatically, based on metadata associated with documents or tasks in that area of responsibility (e.g., upcoming due date that has not been completed, an overdue task or deliverable, etc.) or manually (e.g., a lower level user manually flags a task or an entire area of responsibility for higher-level review).

Other means of alerting the user to the status of tasks or areas of responsibility may be used in system 10. For example, a dashboard for the activity frame 24 may use shapes, as an alternative to or in addition to colors and shading, to denote areas that require attention. Of course, FIG. 2 illustrates a dashboard 30 that is focused on task completion; system 10 may include dashboards that are more focused on business risk. The risk-based dashboards may be used in addition to task-based dashboards or as an alternative to them.

Once a user selects one of the status indicators 32, 34, 36, 38, 40, the activity frame 24 may take the user into a dashboard or workspace, such as the workspace 42 illustrated in FIG. 2, where more specific data can be reviewed. That workspace may also allow the user to do meaningful work and/or allow “drill-down” access to other, lower-level workspaces. In general, dashboards provide the user with information or indications of projects or areas that require attention, and workspaces provide the user with access to the applications 24 that are used to create documents, communicate with team members, and otherwise perform business-related functions. However, the terms “dashboard” and “workspace” may be co-extensive in meaning; in some embodiments, a dashboard may provide some workspace functionality, and vice-versa.

Additionally, as was noted briefly above, in some cases, the applications 26 may be an integrated part of the activity frame 24; in other cases, the activity frame 24 may integrate with commercial software packages. For example, the activity frame 24 may interface with programs like Microsoft Office and Microsoft Exchange (Microsoft Corporation, Redmond, Wash., United States), Jabber servers for instant messaging, and other conventional programs. If the activity frame 24 integrates with other commercial software packages, it may not be visible to the user as part of a graphical user interface; it may instead work in the background to tag all data generated with the appropriate metadata.

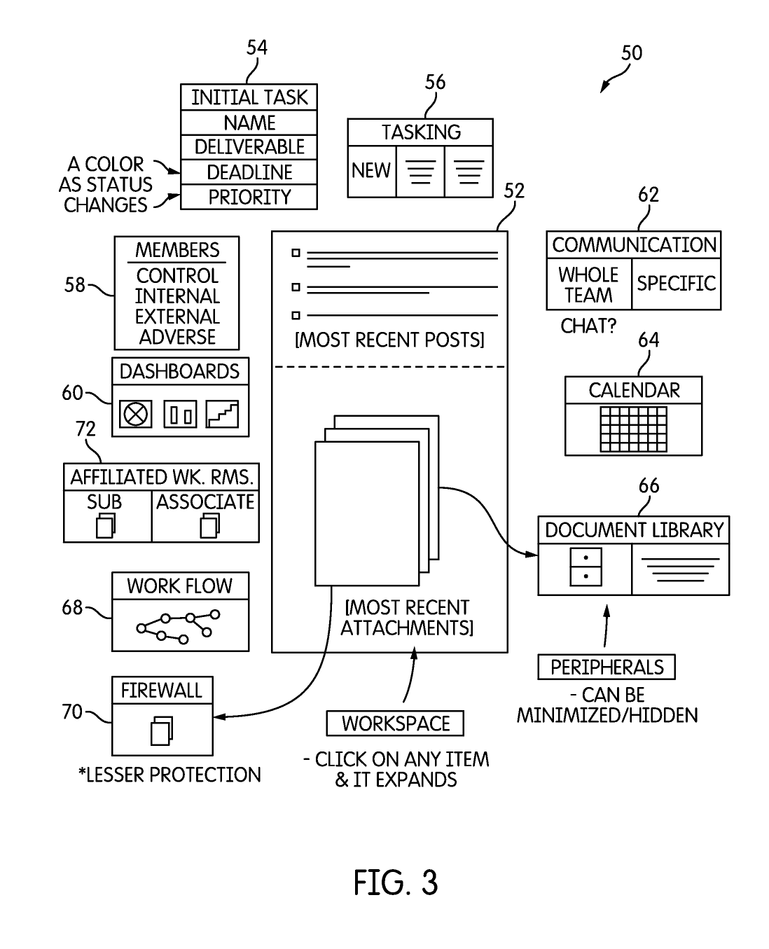

FIG. 3 is a schematic illustration of another workspace 50, showing a number of associated functions. At the center of the workspace 50 is a document center 52 that lists (and, in at least some embodiments, links to) the most recent documents edited, most recent e-mail attachments, and other most recent work product. Arrayed around the document center 52 are a variety of peripheral indicators and access points for managing other aspects of the task and project. In many embodiments, clicking on or otherwise selecting one of the indicators or access points brings it into focus, and may have some other visual interface effect, such as increasing its size and decreasing the sizes of the elements around it. Peripheral indicators and access points that are not in use or not in frequent use may be minimized or hidden altogether.

On the top left in the illustration of FIG. 3, a task status indicator 54 shows the name of the next task due, the nature of the deliverable due, the deadline, and an indicator as to the priority or importance of the task. These indicators, and especially the deadline and priority indications, may be shaded or colored to draw attention as the status of the task changes. To the right of the task status indicator 54, a tasking box 56 allows a user with appropriate rights to assign or delegate specific tasks to specific users (either internal or external to the organization), and just below the task status indicator, a member control 58 allows the user to list and designate the team members associated with the task or project.

System 10 identifies different classes of users and different classes of members for each task and project. The member control 58 allows the user to list the members of the task or project, add new members, and remove existing members. In the illustrated embodiment, members are identified as control members (i.e., members who have control over projects or tasks and the ability to approve or reject proposed due dates, deliverables, etc.), internal members (i.e., members who are employees or otherwise internal to the organization), external members (i.e., members who are outside of the organization), and those adverse in the task or project (e.g., in a legal matter). In system 10, there may be many control members, each with responsibilities at different hierarchical levels. In addition to approving deliverables and due dates, control members in system 10 have the power of delegation—they can designate other team members, within or outside of the organization, as being responsible for certain milestones, tasks, or documents. If the users to whom the tasks have been delegated have “control member” status at their level, they may be able to further delegate tasks or sub-tasks to others. In at least some embodiments, a control member of a higher-level workspace may be able to designate tasks that cannot be delegated, i.e., tasks that, once assigned, must be completed personally by the user to whom they are delegated.

Dashboard selector 60 allows the user to access a variety of dashboards and analytics, including graphs and charts of the current task or project and higher-level dashboards, such as the dashboard 30 of FIG. 2. In some embodiments, other controls, like “back” and “forward” buttons may allow a user to return to a higher or lower level in the hierarchical interfaces and workspaces of system 10.

Other peripheral access points illustrated in FIG. 3 include a communication toolbox 62, which allows the user to initiate communications, such as e-mail communications either to a specific person or to the entire team for the task or project; a calendar 64 for scheduling and coordinating meetings, marking milestones, and otherwise tracking time; and a document library 66 that provides access to all of the documents associated with a task or project. In many embodiments, the document library 66 also provides a search function that allows a user to search for a document or documents using any and all available metadata. Additionally, a workflow toolbox 68 allows the user to create, access, and edit traditional project management and workflow diagrams, timelines, and schedules, and a firewall toolbox 70 allows the user to control which documents and resources for the task or project are kept within an organization's firewalls or other access control restrictions, and which are available to anyone through the communication network 18.

As those of skill in the art will appreciate, the workspace 50 may include any other standard office tools and/or functionalities. In the context of system 10, many of the peripheral indicators and access points 52, 54, 56, 58, 60, 62, 64, 66, 68, 70 illustrated in FIG. 3 act to encode metadata on documents and communications. For example, the members of the team handling the task or project that are entered using the member control 58 may be encoded as metadata on all of the documents and information generated using workspace 50. Similarly, the information in the task status indicator 54 may be encoded as metadata on all of the documents and information generated using workspace 50. (In this context, the phrase “encoded on” should be construed to refer to situations in which the metadata is either stored as a part of the file in which the actual data is stored, or stored separately and in association with the data, as may be the case in a database or a similar type of data repository.) Others of the peripheral indicators and access points 52, 54, 56, 58, 60, 62, 64, 66, 68, 70 may be used to create and store metadata, depending on the embodiment and the nature of the metadata involved.

In addition to the access points and tools described above, workspace 50 also includes some tools that are specific to system 10. For example, FIG. 3 illustrates an affiliated workspace toolbox 72. As was described briefly above, system 10 has a hierarchical relationship among its dashboards 30, workspaces 42, 50, and other elements. For example, the dashboard 30 provides an overview of a broad range of areas of responsibility, indicating for each only whether or not an area requires a user's attention. If the user selects one of the status indicators 32, 34, 36, 38, 40, he or she is taken to a high-level workspace.

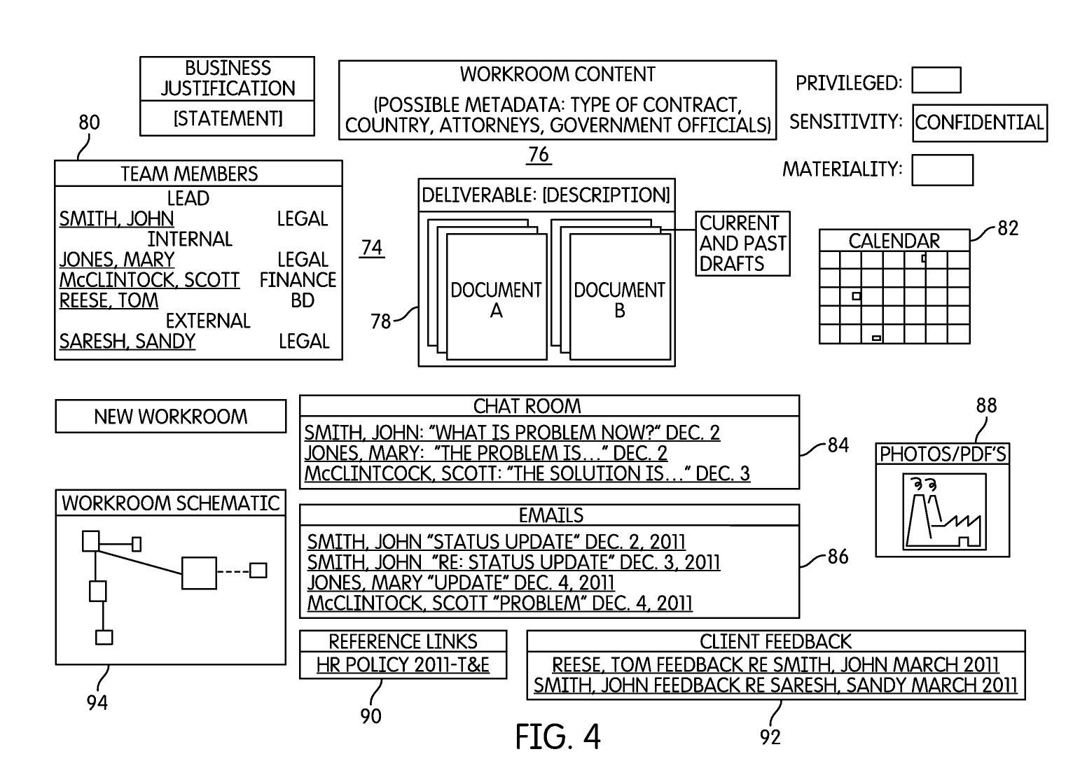

FIG. 4 is another example of a workspace 74, and the manner in which it may be organized. At the top of FIG. 4, in the “header” portion 76 of the workspace 74, metadata about the workspace is displayed, including the mission or justification statement for the task or project, the sensitivity, materiality, and privilege statuses of the task or project, and other basic data about the nature of the project. A number of access points and status indicators are also present, arrayed around a central space for documents 78. Included are a member control 80 that lists the team members and their affiliations, a calendar 82, a chat room 84, an e-mail access point 86, an access point for photographs, portable document format (PDF) documents, and other document resources 88, an access point for reference materials related to the project 90, and an access point for client feedback 92. The workspace 74 also illustrates a workspace schematic 94 that provides the user with the ability to view, manipulate, and enter related workspaces.

Although the description of the workspaces 50, 74 above focuses on specific features of each workspace 50, 74, in some embodiments, workspaces may be visually identical to one another, or have no discernible visual or interface features by themselves, and may differ only in the metadata they encode in the data that is generated by a user working in them. In fact, if the system uses off-the-shelf commercial programs, the user may see virtually no difference in the interface or functionality of those programs operating with an activity frame 24 and workspace as compared to without. Once a user identifies the appropriate workspace for his or her activity, either by entering a project identifier or traversing a visual map of related workspaces, everything that he or she does is encoded with that workspace's metadata and associated with the active workspace. In many embodiments, this may be the case even in with documents that were not originally created within a workspace. For example, an e-mail received by the user may come from outside of the system; however, once received, it is logged into the active workspace.

While the activity frame 24 allows workspaces like workspace 74 to catalog and store all data associated with the projects or tasks for which they were created, in many embodiments of the invention, their ability to do so may be made selective, temporary, or subject to specific rules. Some workspaces 74, and some applications 26, may store their data only until a task or project terminates, or only until a particular deliverable is finished. For example, the contents of a chat room 86 may be deleted when a project's deliverable is complete. This may be accomplished manually (i.e., by a user with sufficient authority or permissions) or automatically. As a more general example, a workspace 74 may be configured to automatically purge or delete its data in response to predefined criteria, such as legal compliance criteria or evidentiary rules. A workspace 74 may also be configured or allowed to purge some data upon completion of a deliverable, like chat room data, but retain other data, like e-mailed communications.

As one example of how hierarchical workspaces are used in system 10, assume that workspace 74 is part of a hierarchy of workspaces in the intellectual property area. The workspace schematic 94 allows the user to access the entire hierarchy (or at least that portion to which the individual user has access rights). In the highest-level workspace, the user is presented with a map of the organization's intellectual property holdings, for example, grouped by property type: patent, trademark, copyright, and trade secret. Using patents as an example, clicking on or otherwise selecting the patent property area in the high-level workspace will take the user to a lower-level workspace where, for example, the user is presented with a listing or map of the major patent families owned or managed by the organization. After selecting one of the families, the user can choose to create a workspace for a new patent application or enter a workspace for an existing patent family.

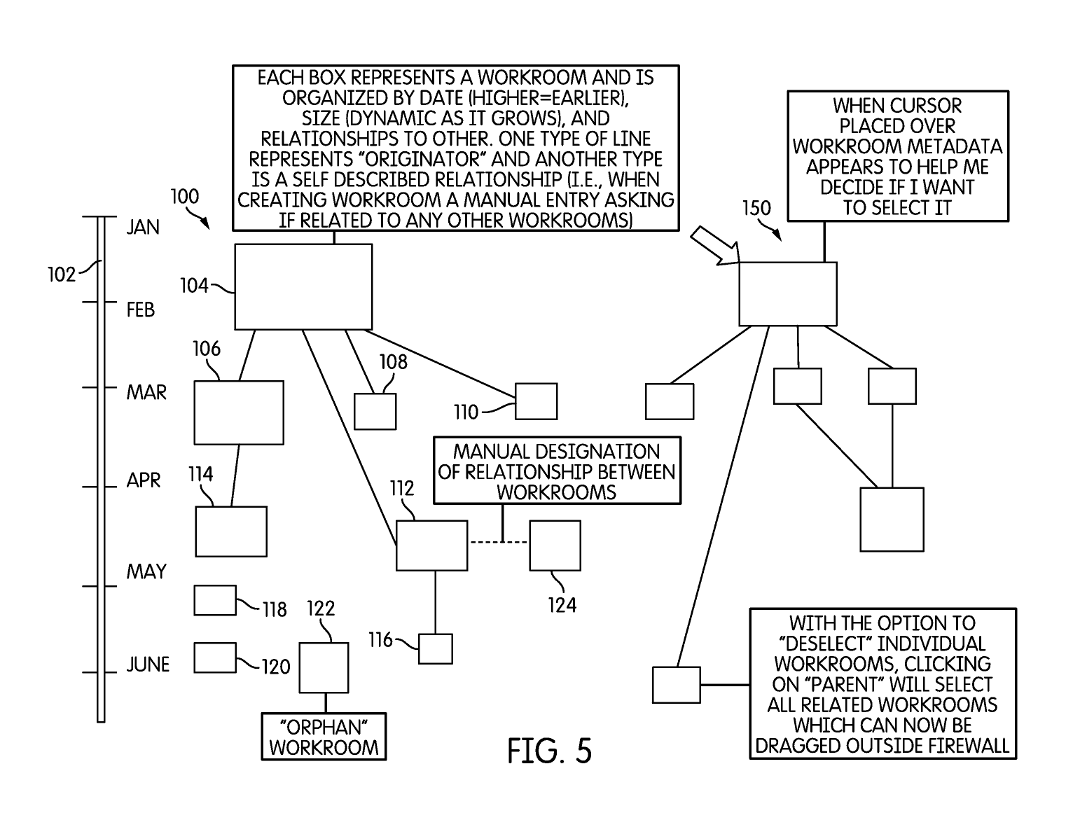

FIG. 5 illustrates this general principle. In particular, FIG. 5 is an illustration of the relationships between a plurality of workspaces. Moreover, some embodiments of system 10 may use an interface like the illustration of FIG. 5 to allow a user to select a workspace in which to work. For example, choosing one of the status indicators and access points 32, 34, 36, 38, 40 on the dashboard 30 of FIG. 1 might cause a family display like that of FIG. 5 to be shown, so that the user can select a workspace. Other interface features may be included. For example, when the user hovers over a workspace with his or her cursor, system 10 may display enough metadata about the workspace to allow the user to decide whether or not he or she wishes to enter it.

FIG. 5 illustrates a first workspace map, generally indicated at 100. As was noted briefly above, system 10 allows workspaces to be hierarchically organized. Specifically, system 10 may allow task-based hierarchies of workspaces, time-based hierarchies, and special relationships or user-defined hierarchies between workspaces. In FIG. 5, a timeline 102 is shown to the left, and the position of each workspace within the workspace map 100 correlates with its age. Additionally, the size of workspace icons in this user interface is used to show the size, usage volume, or amount of data contained by each workspace. Of course, the features of any particular interface may vary from embodiment to embodiment and from organization to organization, and may be customizable at both the user and organizational levels.

In the workspace map 100 of FIG. 5, workspace 104 is the largest and is the root node or originator of much of the hierarchy depicted. Workspace 104 has as children workspaces 106, 108, 110, and 112, of which workspace 112 was opened later than the others, and of which workspace 106 is the busiest. Workspace 104 also has as hierarchical descendants workspace 114, which is a child of workspace 106, and workspace 116, which is a descendant of workspace 116. Each child and grandchild typically represents a specific task or project within the larger area of responsibility of the originating workspace. As one example, assume that during a litigation, it becomes necessary to hire an expert witness to opine on a particular aspect of the litigation. In that case, a child workspace could be created to handle the search and contracting for a qualified expert. The child workspace might include personnel different from those handling the overall litigation. For example, it might include attorneys working on the overall litigation, representatives from the client, and possibly representatives from human resources; however, it would be linked with the master litigation. Similarly, another child workspace might include communications, due dates, and processes related to the actual work product of the expert, once he or she is hired.

FIG. 5 also illustrates that “orphan” workspaces 118, 120, 122 may be created that have no hierarchical relationship with any other workspace in the workspace map 100. Additionally, some workspaces, like workspace 124, may be manually designated as being related to other workspaces. This may be helpful in cases in which two matters may be similar or coextensive, but not related in a hierarchical sense. For example, two patent applications or patents may cover similar subject matter, but may not be in the same hierarchical patent families.

In addition to creating and organizing workspaces, system 10 allows a user to manage their status and security levels. Thus, a workspace family map like workspace family map 100 may be used to create, delete, and change the organization of workspaces within it, provided that the user has sufficient privileges to do so. Additionally, a user may select a number of workspaces within a workspace family map 100 and change their status, metadata, or relationships collectively. Selecting a parent workspace may allow the user to select all subsidiary workspaces within a hierarchy. For example, a user may use that kind of selection process to change the privilege indications, secrecy levels, or other characteristics of workspaces collectively. As another example, in FIG. 5, the user has selected a workspace family map 150, and could “drag” those workspaces outside of an organization's firewall, allowing them to be shared with partner organizations or the public at large.

It should be understood that a workspace map like workspace map 100 may show a user the entire “ecosystem” of workspaces created or under the control of an organization or whatever subset of that ecosystem the individual user is authorized to see and interact with. If that “ecosystem” is large, features may be provided to allow the user to “zoom” in on various parts of the map 100 and to pan or scroll to different parts of the map 100. The graphic elements that represent the individual workspaces in the workspace map 100 may include text or graphical elements to indicate the nature of the workspace itself, the level of sensitivity, and other data or metadata associated with the workspace. In some embodiments, interface features may be included that, for example, magnify or enlarge a workspace in the workspace map 100 when a user “hovers” over it. Other features, like filtering and searching features, may be included to allow a user to select particular groups of workspaces or individual workspaces. Searching features may allow the user to search using either metadata or data contained within the workspaces.

At the highest levels, system 10 encodes at least the basic metadata set forth above in each piece of data. As the user enters lower and lower level workspaces within a hierarchy, system 10 encodes additional information relevant to those workspaces and matters as the user works. For example, in a patent family-level workspace, system 10 might encode the name of the family and lead inventor, the docket or reference number for the family, the earliest priority date or dates for the family, whether the family is being handled internally or by outside counsel, an indication as to the subject matter of the family, etc. In a workspace for an individual application, system 10 might encode the docket or reference number for the individual application, the official application number, the country of the application, the title of the application, the filing date, the priority date, and data on any parent applications, to name a few types of metadata.

The nature and type of metadata that is encoded for any particular workspace at any particular level of system 10 can be specified by control members at the appropriate levels of the hierarchy. In some embodiments, control members may manually define the metadata that is to be collected for any workspace and lower level workspaces that inherit their properties from it. In addition to manual definition for each workspace, in system 10, templates can be used to specify the additional metadata that is collected for particular workspaces. The templates can be pre-defined for particular functions, projects, or tasks and installed with system 10, or they can be defined by control members at higher levels of the hierarchy. Depending on the embodiment, the nature of the project or task, and other factors, control members at lower levels of the hierarchy may add additional metadata fields and define default values for those fields.

It should be understood that in this description, some rights and responsibilities ascribed to control members, such as defining templates and defining the members assigned to a particular project or task, may alternatively or additionally be performed by system administrators who do not have specific operational responsibility over any particular project, task, or workspace.

Tables 1-7 below specify and summarize particular types of metadata that may be collected for different business areas.

TABLE 1
Example Metadata Common to all Workspaces,
Projects, and Tasks.

| Metadata Type | Notes/Examples |
|---|---|
| User | The user who created the data, by name or user |
| | ID number. |
| Date | The date. |
| Team Members | Team members identified by name or ID number. |
| | Either the ID number or a separate code indicates |
| | the type of team member: internal legal, internal |
| | compliance, internal business/finance, internal |
| | scientific, outside legal, outside finance, etc. |
| Purpose/ | A text statement of the purpose or justification |
| Justification | for the task or project. |
| Deliverable | The type of deliverable: completed transaction, |
| | resolved litigation, issued patent, etc. |
| Calendar/ | Deadlines, due dates, and meetings associated with |
| Deadlines | the data. |
| Materiality | An indication of the importance of the data, e.g., |
| | routine, high, priority. |
| Privileged | A field indicating whether or not the data is legally |
| | privileged. |
| Sensitivity | A field indicating how sensitive the data is, e.g., |
| | business confidential, need to know only, public. |

TABLE 2
Example Metadata for Business Development

| Metadata Type | Notes/Examples |
|---|---|
| Target | The name of the target company. |
| Company Name | |
| Antitrust | An indication as to whether or not the target company |
| Implications | or matter might have antitrust implications in a |
| | particular jurisdiction or in general. |
| Potential | The potential size of the opportunity, typically in |
| Size of | quantitative terms. |
| Opportunity | |
| Type of | An indication as to the type of transaction or trans- |
| Transactions | actions, e.g., license, acquisition, divestiture, or |
| | joint venture. |
| Country of | The country in which the target company, intellectual |
| Target | property, or opportunity exists. |

TABLE 3
Example Metadata for Investigations

| Metadata Type | Notes/Examples |
|---|---|
| Type | The type of investigation, e.g., corruption, anti- |
| | trust, human rights, HR, export controls, etc. |
| Source | The source of the complaint or issue, e.g., hotline, |
| | anonymous, government agency, employee, vendor, |
| | partner, internal audit. |

TABLE 4
Example Metadata for Litigation

| Metadata Type | Notes/Examples |
|---|---|
| Adverse Parties | An indication of the adverse parties in the litigation. |
| Relevant | An indication of relevant third parties. |
| Third Parties | |
| Type | The type of litigation, e.g., employment, IP, contract, |
| | antitrust, marketing practices, etc. |
| Lead firm | An indication of the lead outside counsel for the |
| | matter. |
| Potential | An indication in quantitative terms of the level of |
| Exposure/ | financial exposure or opportunity in the litigation. |
| Opportunity | |
| Adverse | An indication (YES/NO) of whether an adverse injunc- |
| injunction | tion is possible. |
| possible | |
| Impacted | An indication of the departments or business areas |
| Departments | impacted by the litigation. |

TABLE 5
Example Metadata for Intellectual Property Matters

| Metadata Type | Notes/Examples |
|---|---|
| Type | The type of intellectual property matter, e.g., patent, |
| | trademark, trade secret, copyright. |
| Ownership/ | An indication of the ownership or source of the intel- |
| Source | lectual property, e.g., third party company, internal/ |
| | employee, or consultant. |
| Outside | An indication of the outside counsel for the matter. |
| Counsel | |
| Size of | An indication in quantitative terms of the size of the |
| opportunity | opportunity. |
| Core to | An indication of whether or not the intellectual property |
| Business | is core to a business area. |

TABLE 6
Example Metadata for Financing Transactions

| Metadata Type | Notes/Examples |
|---|---|
| Type | The type of financing transaction, e.g., equity, debt, |
| | factoring, etc. |
| Bank | The bank providing the financing or handling the trans- |
| | action. |
| Amount | The amount of the financing in quantitative terms. |
| SEC Filing | An indication of whether or not a Securities and |
| | Exchange Commission filing is necessary. |

TABLE 7
Example Metadata for Compliance (Corruption) Matters

| Metadata Type | Notes/Examples |
|---|---|
| Country | An indication of the country involved. |
| Government | An indication of whether or not government officials are |
| Officials | involved. |
| Third | An indication of the identity of any third party agent |
| Party Agent | acting on behalf of the organization in the matter. |

In Tables 1-7 above, and in defining metadata generally, the actual datatypes of the metadata fields (e.g., integer, Boolean, string, array, structure, enumeration) may vary from embodiment to embodiment and implementation to implementation, depending on the type of data repository 20 and other factors. These are not critical, so long as the desired metadata can be stored, indexed, and used.

One advantage of system 10 is the ability to use the metadata encoded with data to facilitate higher-level review and analysis of processes that are occurring. For example, the “size of the opportunity” and “potential exposure/opportunity” metadata fields can be used in higher-level analysis to calculate projected profits, expenditures, liabilities, and other metrics derived from them. Such metadata fields can also be used to “flag” larger matters for higher-level review.

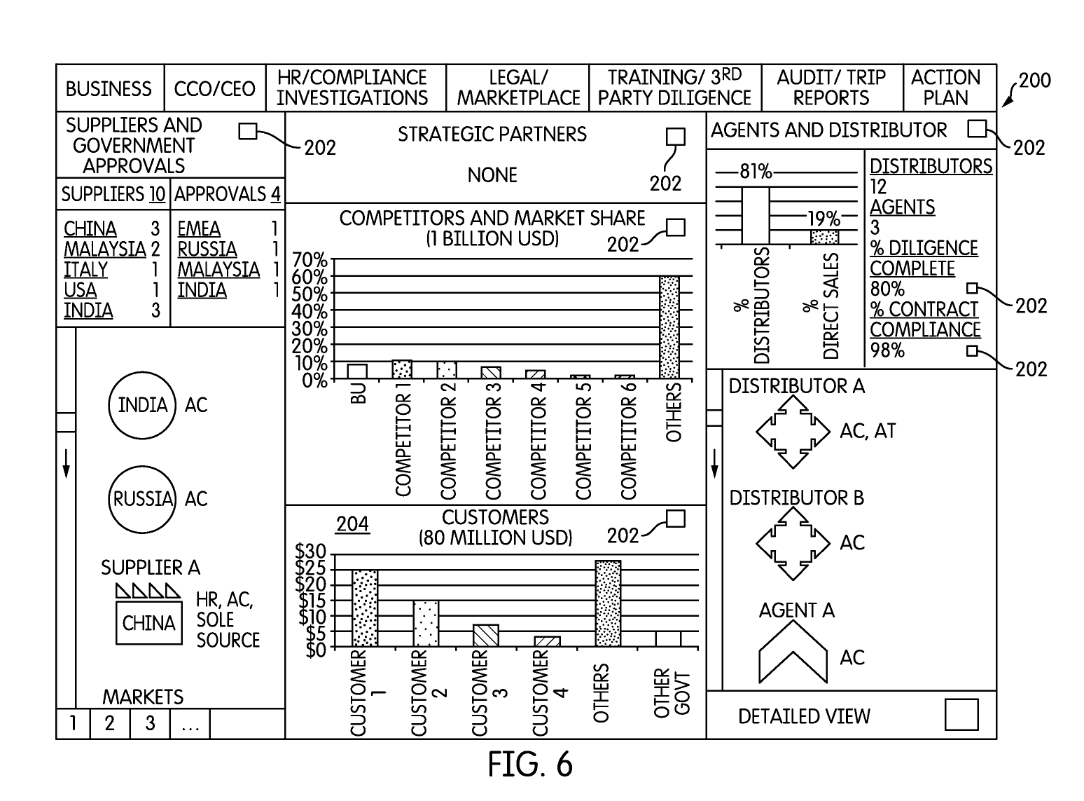

FIG. 6 is an illustration of a general business analytical dashboard 200. The general business analytical dashboard 200 provides information on suppliers and government approvals, markets, customers and volume of customer business, competitors and market share, agents, and distributors. Each area has an indicator 202, which indicates whether the area requires attention from the user. The indicators 202 may use color, shape, animation, or any other kind of display characteristics to draw attention. In one embodiment, a classic green (ok/good/low risk), yellow (may require attention/medium risk), and red (requires immediate attention/high risk). The state of these indicators 202 may be based on the metadata collected in particular workspaces or on manual flagging of a matter as requiring attention.

Notably, the information presented in the business analytical dashboard 200 may be based on the metadata that is gathered in system 10, on the data in the workspaces 50, 74, or on a combination of both. For example, the “size of opportunity” and “amount of opportunity” metadata fields, as well as other, similar fields, may be summed across multiple workspaces and projects and used to generate an analytic showing the total magnitude of business opportunities, the total magnitude of financing, etc. In other situations, metadata may be compared with the actual data generated in a workspace. For example, the “size of opportunity” metadata may be summed and compared with actual opportunity size data from the relevant workspace or workspaces.

Of course, clicking on or otherwise selecting one of the data displays in the analytical dashboard 200 will take the user to a relevant workspace or workspaces. For example, as shown in FIG. 6, the analytical workspace 200 contains a customer data display 204. The customer data display shows the sales volume for a number of customers, in this case, using a bar graph. If the user selects one of the customers or one of the bars on the bar graph, he or she may be taken to a high-level workspace for that client, from which he or she can navigate the hierarchical map of workspaces for that client.

While the invention has been described with respect to certain embodiments, the embodiments are intended to be exemplary, rather than limiting. Modifications and changes may be made within the scope of the invention, which is defined by the appended claims.

What is claimed is:

1. A project management system, comprising:
a data repository; and
one or more computing systems in communication with the data repository, each of the computing systems running an activity frame that is configured and adapted to:
provide a set of workspaces for a corresponding set of projects or tasks, such that each workspace has a corresponding project or task,
automatically associate metadata appropriate to the corresponding project or task with each piece of data generated, received, or acted upon while in one of the set of workspaces, regardless of the origin of the piece of data, and
store the data and the metadata in the data repository.

2. The project management system of claim 1, wherein ones of the set of workspaces have hierarchical relationships with one another.

3. The project management system of claim 2, wherein the activity frame is further configured and adapted to provide a listing or representation of the set of workspaces and their relationships and to allow a user to: (1) select one of the set of workspaces in which to work; (2) select one or more of the set of workspaces; and (3) change one or more characteristics of the selected workspaces, if the user has a defined level of permissions.

4. The project management system of claim 1, wherein the computing systems are further configured and adapted to store essentially all of the data and the metadata in the data repository.

5. The project management system of claim 1, wherein the computing systems are further configured and adapted to purge selected elements of the data in accordance with predetermined rules.

6. A method for associating data with metadata, comprising:
defining a set of virtual workspaces that can be accessed and used with a computing system, at least some of the set of virtual workspaces having relationships with one another, and each of the set of virtual workspaces having an associated set of metadata;
allowing a user to use one or more applications on the computing system in association with a first one of the set of virtual workspaces; and
automatically storing the set of metadata associated with the first virtual workspace in association with data generated, received, or acted upon by the one or more applications in association with the first virtual workspace.

7. The method of claim 6, wherein at least some of the set of virtual workspaces have hierarchical relationships with one another.

8. The method of claim 7, wherein the associated sets of metadata are based, at least in part, on the hierarchical relationships.

9. The method of claim 6, further comprising providing a representation or listing of the set of virtual workspaces.

10. The method of claim 9, further comprising moving from the first virtual workspace to a second virtual workspace based on a user selection of one of the set of workspaces in the representation or listing.

11. The method of claim 9, further comprising changing attributes of one or more of the set of virtual workspaces based on a user selection in the representation or listing.

12. The method of claim 6, further comprising providing multiple users with access to the set of virtual workspaces.

13. The method of claim 6, further comprising generating an indication that attention to a particular one of the set of workspaces is necessary, said generating being based on one or more of the data, the associated set of metadata, or a comparison of the data or the metadata with predetermined criteria.

14. The method of claim 13, further comprising providing a dashboard, the dashboard directly or indirectly displaying the status of the set of workspaces and including the indication that attention is necessary.
